(19) United States
(12) Patent Application Publication
(10) Pub. No.: US 2003/0174238 A1
(43) Pub. Date: Sep. 18, 2003

(54) Hot-swappable camera head system and method

(76) Inventor: Vic Chi-Shi Wu, Irvine, CA (US)

Correspondence Address: LAW OFFICE OF GERALD MALISZEWSKI, 11440 WEST BERNARDO COURT, SUITE 157, SAN DIEGO, CA, 92127, US

(21) Appl. No.: 10/095,660

(22) Filed: Mar. 12, 2002

(51) Int. Cl. H04N 5/225

(52) U.S. Cl. 348/373

(57) ABSTRACT

A system and method are provided for a hot-swappable digital camera head. The system comprises a processing unit with a port to receive digital image information from a camera head. The processing unit includes a memory, and a digital signal processor to process the image information and compress it for storage in the memory. The processor unit can supply either processed (raw) image information, or compressed image information. The detachable head includes a lens, a light sensing device, and a port for connection to the processing unit port, to supply the digital image information. The processing unit can be attached to one of a plurality of head models, where each head model supplies digital image information in a potentially different image information format. The differences in formats can be related to the light sensing device used or variance between manufacturer interfaces. The processing unit memory includes a plurality of selectable processing applications for operating the digital signal processor, where each processing application corresponds to one of the different image information formats. The head port supplies a model signal to indicate the model of the head. The processing unit reads the model signal and selects a processing application from memory in response to the model signal. Following the selection of the processing application, the processor unit operates the digital signal processor with the selected processing application.

### BACKGROUND OF THE INVENTION

1. Field of the Invention

This invention generally relates to digital cameras and, more particularly, to a digital camera system and method for a hot-swappable camera head.

2. Description of the Related Art

FIG. 1 is a schematic block diagram of a conventional digital camera (prior art). Images are focused through the lens on to a charge coupled device (CCD). The analog output of the CCD is converted into digital image information by an analog to digital (A/D) converter. Note that other light sensing devices, of which the CCD is just an example, have a digital output signal, so that the A/D is unnecessary. A processor processes the image, perhaps adjusting contrast, and compresses the image information. The compressed image information is supplied at an output and/or stored in a memory, such as a Flash memory.

Digital cameras are commonly used for applications such as web camera, multimedia, videoconference, videophone, home monitoring, and machine vision. Different camera types are installed in systems and used for different applications, in response to requirements such as quality, cost, and environment. However, requirements change in response to changes in environment, or system needs. A change in image data requirements can necessitate a change in the light sensing device and/or the image processing algorithm. As a result, the system cameras have to be replaced, with the expense of higher maintenance and equipment costs. Furthermore, it is cumbersome and expensive for manufacturers, distributors, and installers to stock a wide array of camera models. The difference between some models is merely a different type of sensors in the camera head.

It would be advantageous if a digital camera did not be replaced, just because the image requirements imposed upon the camera change.

It would be advantageous if the processing unit of a digital camera could be reused, even in the light sensing device in the camera head needed to be replaced.

It would be advantageous if the head of the camera could be replaced, without damaging the camera, when the camera was on.

### SUMMARY OF THE INVENTION

The present invention hot-swappable camera head reduces the time and cost of re-installation and re-configuration, and it will also help reduce a manufacturer's and distributor's stocking cost. The present invention includes three features. The camera head has been made separable from the processing system. A quick connect/disconnect connector is used. Camera heads can be disconnected or connected without the requirement of turning off the power. Signaling means inside the camera head permit the processing module to auto-sense the type of video sensor in the head module and automatically reconfigure the processing format for proper image processing.

Accordingly, a hot-swappable camera head system is provided comprising a processing unit with a port to receive digital image information from a camera head. The processing unit includes a memory, and a digital signal processor to process the image information and compress it for storage in the memory. The processor unit can supply either processed (raw) image information, or compressed image information. The detachable head includes a lens, a light sensing device, and a port for connection to the processing unit port, to supply the digital image information.

Further, the processing unit can be attached to one of a plurality of head models, where each head model supplies digital image information in a potentially different image information format. The differences in formats can be related to the light sensing device used or variance between manufacturer interfaces. The processing unit memory includes a plurality of selectable processing applications for operating the digital signal processor, where each processing application corresponds to one of the different image information formats. The head port supplies a model signal to indicate the model of the head. The processing unit reads the model signal and selects a processing application from memory in response to the model signal. Following the selection of the processing application, the processor unit operates the digital signal processor with the selected processing application.

Additional details of the above-described system, and a method for a hot-swappable camera head are provided below.

### BRIEF DESCRIPTION OF THE DRAWINGS

FIG. 1 is a schematic block diagram of a conventional digital camera (prior art).

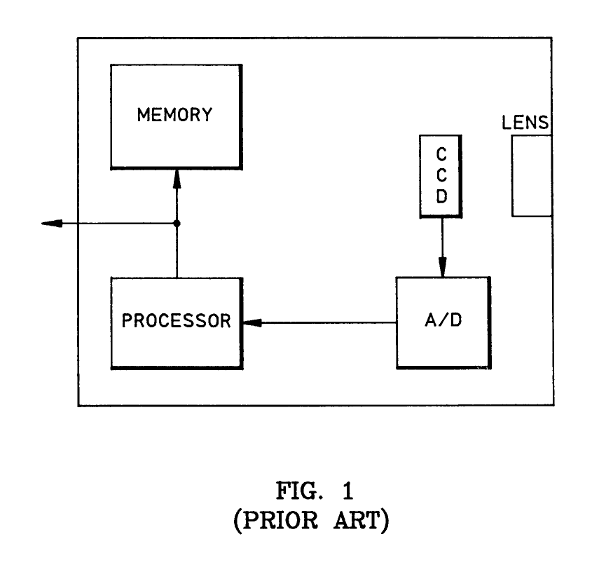

FIG. 2 is a schematic block diagram of the present invention hot-swappable camera head system.

FIG. 3 is a schematic block diagram illustrating the configuration aspect of the system of FIG. 2.

FIG. 4 depicts an alternate aspect of the configuration circuit of FIG. 3.

FIG. 5 is a diagram illustrating the hot-swappable connection feature of the present invention system of FIG. 2.

FIG. 6 is a flowchart illustrating the present invention method for hot-swapping a camera head.

### DETAILED DESCRIPTION OF THE PREFERRED EMBODIMENTS

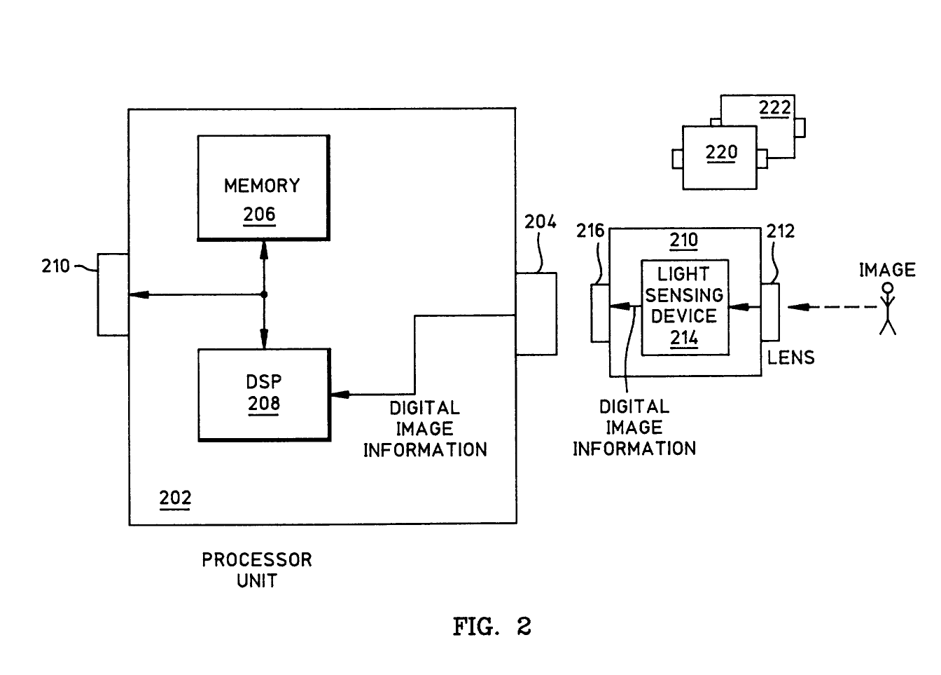

FIG. 2 is a schematic block diagram of the present invention hot-swappable camera head system. The system 200 comprises a processing unit 202 having a port 204 to receive digital image information and a memory 206. A digital signal processor (DSP) 208 processes the image information and compresses it for storage in the memory 206. A port 210 is capable of supplying either processed image information or compressed image information.

The DSP 208 is one of a special type of microprocessor designed for image processing applications. The DSP 208 is understood to a conventional device, as would be well understood by one practiced in the art, and a detailed discussion of this part is omitted in the interest of brevity. However, the present invention system 200 is not limited to the use of a DSP, and other, more general purpose, microprocessors can be used in other aspects of the invention.

A detachable head 210 including a lens 212 and a light sensing device 214. A port 216 connects to the processing unit port 201, to supply the digital image information. The head light sensing device 214 can be a charge coupled device (CCD), CMOS, infrared (IR), high sensitivity, color, or monochrome devices. The present invention system is not limited to any particular group of light sensing device. The above-mentioned light sensing devices are an incomplete list of examples. When the light sensing device has an analog output, such as a CCD, an A/D (not shown) is included in the head to supply a digital signal to the processing unit 202. Alternately, the processing unit 202 includes an A/D converter (not shown) that can be selectively connected to convert analog image information to digital image information, when needed.

The camera system 200 includes a plurality of detachable head models. Beside head 210, heads 220 and 222 are shown. Each head model supplies digital image information in a corresponding plurality of image information formats. The difference in format can be related to different light sensing devices. For example, head 210 may supply monochrome image information, while head 220 supplies color image information. Alternately, the difference in format may be related to the difference between manufacturer interfaces. For example, the image information may be passed through a plurality of signal lines that may vary in order depending on the manufacturer. Of course, this example assumes that manufacturers are using a standardized (common) connector type. Formats include information concerning the image size, contrast correction (gamma correction factor), pixel aspect ratio, lens correction factor, and color correction factor, to name but a few examples.

The processing unit memory 206 includes a plurality of selectable processing applications for operating the digital signal processor 208. Each processing application corresponds to one of the plurality of image information formats. The head port 216 supplies a model signal to indicate the model of the head 210. The processing unit 202 reads the model signal, and selects a processing application from memory 206 in response to the model signal. Following the selection of the processing application, the processing unit 202 operates the digital signal processor 208 with the selected processing application.

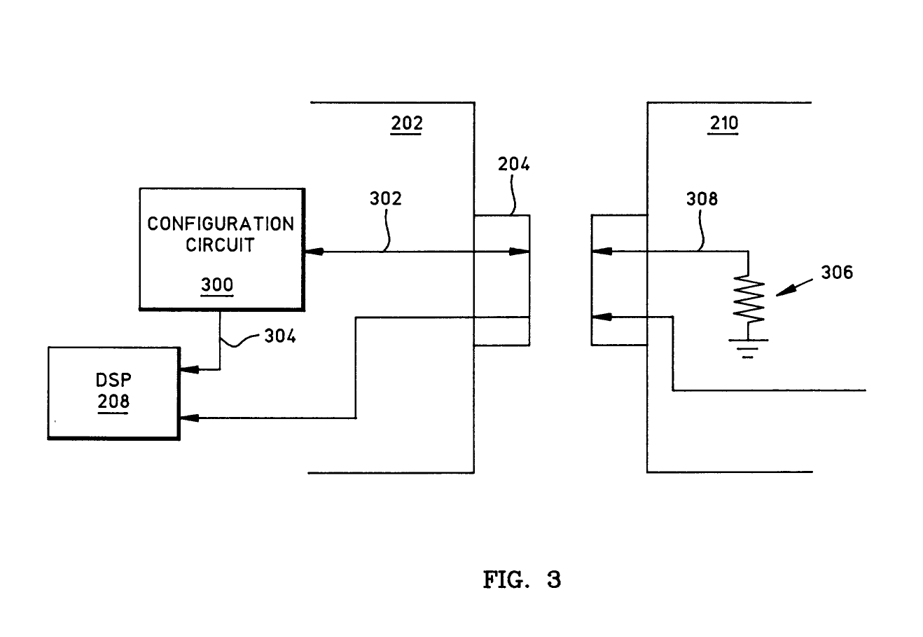

FIG. 3 is a schematic block diagram illustrating the configuration aspect of the system 200 of FIG. 2. Typically, the processing unit 202 checks for configuration upon initialization. Initialization can occur when the processing unit 202 is turned on, or when a head 210 is attached. A configuration circuit 300 has an output connected to the first port 204 on line 302 to supply a configuration signal. The configuration circuit has an output on line 304 to supply an application signal to the DSP 208. In this aspect of the system 200, each head, of which head 210 is representative, includes a shunt resistor 306, corresponding to the head model, that is connected to receive the configuration signal on line 308. For example, a CCD model head may have a 10 k ohm resistor and an IR model head may have a 1 k ohm resistor. The processing circuit 202 reads the model signal by measuring the voltage of the configuration signal on line 302 and supplies an application signal in response. Using the example above, the configuration circuit 300 may read 5 volts for a CCD model head and 3 volts for an IR model head. The digital signal processor 208 has an input on line 304 to receive the application signal, and selects a processing application from memory (not shown) in response to the application signal.

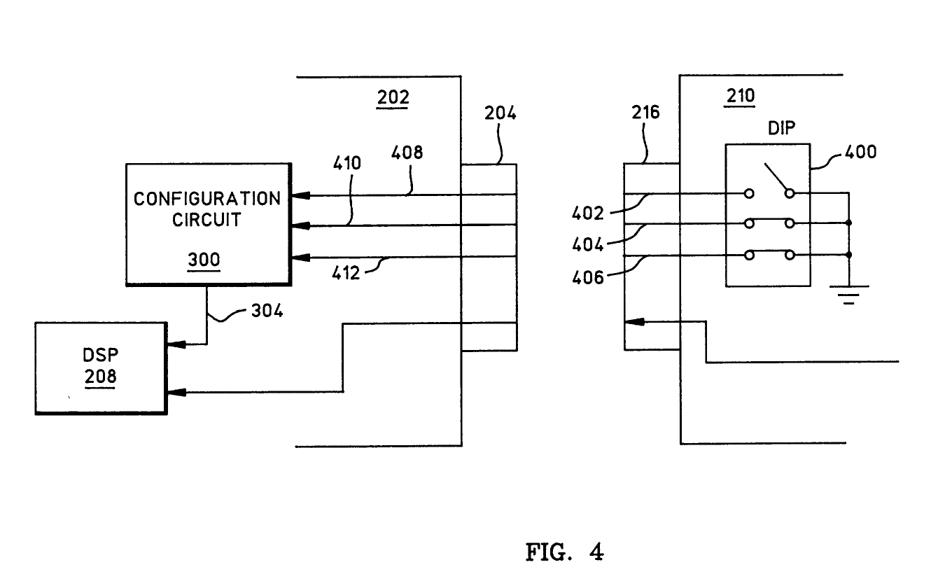

FIG. 4 depicts an alternate aspect of the configuration circuit 300 of FIG. 3. In this aspect, each head, of which head 210 is representative, includes a selectable dual in-line package (DIP) switch 400 to create a digital code signal supplied at the port 216 on lines 402, 404, and 406. The configuration circuit 300 has an input connected to the first port 204 with lines 408, 410, and 412. The configuration circuit 300 reads the model signal by interpreting the digital code signal on lines 408-412 and, in response, supplies an application signal at an output on line 304. As shown, and assuming the existence of a pull-up voltage on lines 408-412, the digital code would be 100. As above, the digital signal processor has an input on line 304 to receive the application signal. The digital signal processor 208 selects a processing application from memory (not shown) in response to the application signal. Many other means besides a DIP switch, such as hardwiring, could also be used to enable a digital code. Neither is the invention limited to a particular number of bits in the code.

Alternately but not shown, additional circuitry could be used to interpret the application signal supplied by the configuration circuit 300 and provision the DSP 208 with the proper processing application from memory. In other aspects of the system, the processing applications are stored in DSP internal memory.

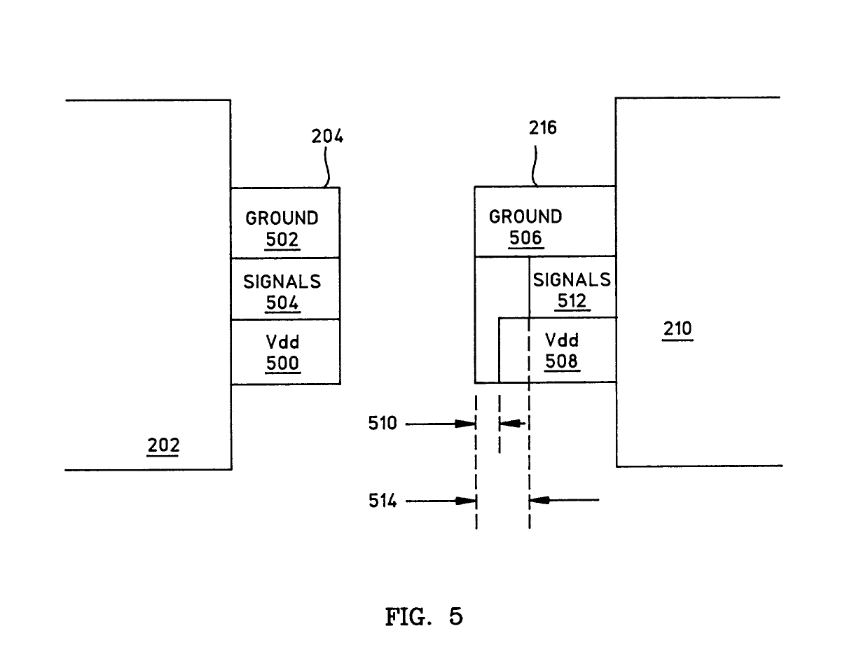

FIG. 5 is a diagram illustrating the hot-swappable connection feature of the present invention system of FIG. 2. The processing unit port 204 includes a connector with dc supply voltage (Vdd) 500, ground 502, and signal 504 interfaces. Note that each of the above-mentioned interfaces may include more than one line, signal trace, or pin. Likewise, each head, of which head 210 is representative, includes a connector 216 with a ground interface 506, a dc supply voltage (Vdd) interface 508 recessed a first distance 510 in from the ground interface 506, and a signal interface 512 recessed a second distance 514, greater than the first distance 510, from the ground interface 506. Note that the above-mentioned recessed connection concept is applicable to a wide variety of otherwise conventional connectors, which are not detailed herein in the interest of brevity. Alternately but not shown, the processor unit port 204 and head port 216 can be reversed, so that the recessed interfaces occur at port 204 and the non-recessed interfaces occur at port 216.

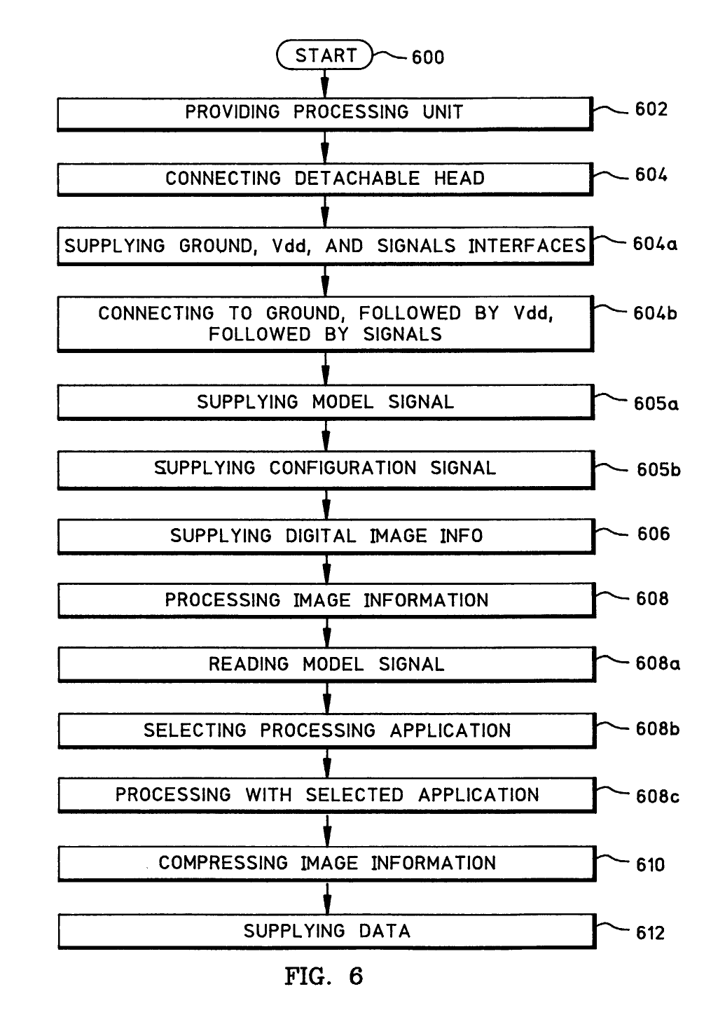

FIG. 6 is a flowchart illustrating the present invention method for hot-swapping a camera head. This method generally corresponds to FIG. 2. Although this method is depicted as a sequence of numbered steps for clarity, no order should be inferred from the numbering unless explicitly stated. It should be understood that some of these steps may be skipped, performed in parallel, or performed without the requirement of maintaining a strict order of sequence. The methods start at Step 600. Step 602 provides a processing unit to receive digital image information from a camera head. Step 604 connects a detachable head including a lens and a light sensing device to the processing unit. Step 606 supplies digital image information to the processing unit. Step 608 processes the supplied image information. Step 610 compresses the image information for storage. Step 612 supplies data, either processed image information, or compressed image information.

In some aspects of the method, connecting a detachable head in Step 604 includes connecting a detachable head having a light sensing device that can be a charge coupled device (CCD), CMOS, infrared (IR), color, high sensitivity, or monochrome device, to name but a few examples.

In some aspects, supplying digital image information to the processing unit in Step 606 includes supplying digital information in one of a plurality of image information formats. Then, processing the supplied image information in Step 608 includes processing the supplied image information with one of a plurality of processing applications corresponding to the image information format.

Some aspects of the method include a further step. Step 605a, in response to connecting the head, supplies a model signal from the head corresponding to the image information format. Then, processing the received image information with one of a plurality of processing applications corresponding to the image information format in Step 608 includes substeps. Step 608a reads the model signal. Step 608b selects a processing application in response to reading the model signal. Step 608c, after the processing application is selected, processes the image information with the selected processing application.

For example, in one aspect each head includes a shunt resistance corresponding to the image information format, and the method comprises a further step. Step 605b, in response to connecting the head, supplies a configuration signal to the head shunt resistance. Then, supplying a model signal corresponding to the image information format in Step 605a includes creating a voltage at the head shunt resistance, in response to the configuration signal. Reading the model signal in Step 608a includes measuring the voltage at the head shunt resistance.

In other aspects, each head includes a selectable dual in-line package (DIP) switch. Then, supplying a model signal from the head in Step 605a includes using the DIP switch to create a digital code model signal. Reading the model signal in Step 608a includes interpreting the digital code signal.

In some aspects, connecting a detachable head in Step 604 includes substeps. Step 604a supplies dc supply voltage (Vdd), ground, and signal interfaces from the processing unit. Step 604b, at the head, connects to the ground, connects to the dc supply voltage after connecting to the ground, and connects to the signal interface after connecting to the dc supply voltage. Alternately, Step 604a supplies dc supply voltage, ground, and signal interfaces from the head. Then, Step 604b, at the processing unit, connects to the ground, connects to the dc supply voltage after connecting to the ground, and connects to the signal interface after connecting to the dc supply voltage.

A system and method have been provided for a hot swappable digital camera head. A few examples have been given of connection specifics and light sensing devices. However, the invention is not limited to merely these examples. Other variations and embodiments of the invention will occur to those skilled in the art.

We claim:

1. A hot-swappable camera head system comprising:
a processing unit having a first port to receive digital image information, a memory, a digital signal processor to process the image information and compress it for storage in the memory, and a second port to supply data selected from the group including processed image information and compressed image information; and,
a detachable head including a lens, a light sensing device, and a port for connection to the processing unit first port, to supply the digital image information.

2. The camera system of claim 1 wherein the head light sensing device is selected from the group including charge coupled device (CCD), CMOS, infrared (IR), color, high sensitivity, and monochrome devices.

3. The camera system of claim 1 further comprising:
a plurality of detachable head models, each head model supplying digital image information in a corresponding plurality of image information formats; and,
wherein the processing unit memory includes a plurality of selectable processing applications for operating the digital signal processor, each processing application corresponding to one of the plurality of image information formats.

4. The camera system of claim 3 wherein the head port supplies a model signal to indicate the model of the head; and,
wherein the processing unit reads the model signal, selects a processing application from memory in response to the model signal, and following the selection of the processing application, operates the digital signal processor with the selected processing application.

5. The camera system of claim 4 further comprising:
a configuration circuit having an output connected to the first port to supply a configuration signal and an output to supply an application signal;
wherein each head includes a shunt resistor, corresponding to the head model, that is connected to receive the configuration signal;
wherein the processing circuit reads the model signal by measuring the voltage of the configuration signal and supplies an application signal in response; and,
wherein the digital signal processor has an input to receive the application signal, and selects a processing application from memory in response to the application signal.

6. The camera system of claim 4 wherein each head includes a selectable dual in-line package (DIP) switch to create a digital code signal supplied at the port; and,
the system further comprising:
a configuration circuit having an input connected to the first port, the configuration circuit reading the model signal by interpreting the digital code signal and, in response, supplying an application signal at an output; and,
wherein the digital signal processor has an input to receive the application signal, the digital signal processor selecting a processing application from memory in response to the application signal.

7. The camera system of claim 4 wherein the processing unit port includes a connector with dc supply voltage, ground, and signal interfaces; and,
wherein each head includes a connector with a ground interface, a dc supply voltage interface recessed a first distance in from the ground interface, and a signal interface recessed a second distance, greater than the first distance, from the ground interface.

8. The camera system of claim 4 wherein each head port includes a connector with dc supply voltage, ground, and signal interfaces; and,
wherein the processing unit includes a connector with a ground interface, a dc supply voltage interface recessed a first distance from the ground interface, and a signal interface recessed a second distance, greater than the first distance, from the ground interface.

9. A method for hot-swapping a camera head, the method comprising:
providing a processing unit to receive digital image information from a camera head;
connecting a detachable head including a lens and a light sensing device to the processing unit; and,
supplying digital image information to the processing unit.

10. The method of claim 9 further comprising:
processing the supplied image information;
compressing the image information for storage; and,
supplying data selected from the group including processed image information and compressed image information.

11. The method of claim 10 wherein connecting a detachable head includes connecting a detachable head having a light sensing device selected from the group including charge coupled device (CCD), CMOS, infrared (IR), color, high sensitivity, and monochrome devices.

12. The method of claim 10 wherein supplying digital image information to the processing unit includes supplying digital information in one of a plurality of image information formats; and,
wherein processing the supplied image information includes processing the supplied image information with one of a plurality of processing applications corresponding to the image information format.

13. The method of claim 12 further comprising:
in response to connecting the head, supplying a model signal from the head corresponding to the image information format; and,
wherein processing the received image information with one of a plurality of processing applications corresponding to the image information format includes:
reading the model signal;
selecting a processing application in response to reading the model signal; and,
after the processing application is selected, processing the image information with the selected processing application.

14. The method of claim 13 in which each head includes a shunt resistance corresponding to the image information format, and the method further comprising:
in response to connecting the head, supplying a configuration signal to the head shunt resistance;
wherein supplying a model signal corresponding to the image information format includes creating a voltage at the head shunt resistance, in response to the configuration signal; and,
wherein reading the model signal includes measuring the voltage at the head shunt resistance.

15. The method of claim 13 in which each head includes a selectable dual in-line package (DIP) switch; and,
wherein supplying a model signal from the head includes using the DIP switch to create a digital code model signal; and,
wherein reading the model signal includes interpreting the digital code signal.

16. The method of claim 13 wherein connecting a detachable head includes:
supplying dc supply voltage, ground, and signal interfaces from the processing unit; and,
at the head, connecting to the ground, connecting to the dc supply voltage after connecting to the ground, and connecting to the signal interface after connecting to the dc supply voltage.

17. The method of claim 13 wherein connecting a detachable head includes:
supplying dc supply voltage, ground, and signal interfaces from the head; and,
at the processing unit, connecting to the ground, connecting to the dc supply voltage after connecting to the ground, and connecting to the signal interface after connecting to the dc supply voltage.

18. A hot-swappable camera head system comprising:
a processing unit having a first port to receive digital image information, a memory, a digital signal processor to process the image information and compress it for storage in the memory, and a second port to supply data selected from the group including processed image information and compressed image information;
a plurality of detachable head models, each head model including a lens, a light sensing device, and a port for connection to the processing unit first port, to supply the digital image information in a corresponding plurality of image information formats; and,
wherein the processing unit memory includes a plurality of selectable processing applications for operating the digital signal processor, each processing application corresponding to one of the plurality of image information formats.
